(19) United States
(12) Patent Application Publication
(10) Pub. No.: US 2014/0379170 A1
(43) Pub. Date: Dec. 25, 2014

(54) LOCATION BASED DRIVE STRATEGY

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(21) Appl. No.: 13/925,480

(22) Filed: Jun. 24, 2013

(51) Int. Cl. G06F 7/00

(52) U.S. Cl. CPC G06F 7/00
USPC 701/2; 701/1

(57) ABSTRACT

Apparatuses and methods are described for selecting a drive strategy based on a vehicle location. A vehicle's location may be received and used to select a drive strategy for that particularly location. The location may also be used to select a geo zone that encompasses the location. The selected drive strategy may also be based on the geo zone. The vehicle may then enforce the drive strategy such that the vehicle's operation complies with or follows the drive strategy.

### BACKGROUND OF THE INVENTION

1. Field of the Invention

The invention relates to vehicle drive strategies based on a vehicle's position that may be determined using the global positioning system (“GPS”).

2. Related Art

Vehicles and vehicle operators use drive strategies to manage the operation of the vehicle. For example, a drive strategy may include a series of shift points for shifting into gears of a transmission. A vehicle operator may implement a drive strategy by making decisions to manually shift into certain gears based on the revolutions-per-minute (“RPMs”) of the engine, based on the grade of the roadway, weather conditions, or other environmental and operating factors of the vehicle.

Alternatively, the drive strategy may be implemented electronically. For example, a computer-controlled transmission may shift the gears of a transmission depending on various inputs such as engine RPMs, vehicle speed, accelerator position, and the position of a transmission shift strategy selector, e.g., a switch that allows the transmission to enter into “fuel economy” mode or “sport” mode.

Drive strategies may also include limitations or targets for fuel economy or emissions. For example, a particular drive strategy may be implemented to achieve a target fuel economy. When being enforced on the vehicle, the drive strategy may result in certain shifting, acceleration, and fuel management decisions that increase the miles per gallon achieved by the vehicle.

Some vehicles do not include any automated drive strategy and instead rely mainly on the vehicle operator to select and implement a drive strategy. Other vehicles may have a drive strategy programmed into an onboard computer or controller that implements the drive strategy on the vehicle.

Certain drive strategies, whether manual or automated, may not be appropriate or desired in certain locations. Thus, there is a need for a system that manages drive strategies in certain locations.

### SUMMARY OF THE INVENTION

The descriptions below include apparatuses and methods for selecting a drive strategy based on a vehicle location. A vehicle's location may be received and used to select a drive strategy for that particularly location. The location may also be used to select a geographical zone, or geo zone, that encompasses the location. The selected drive strategy may also be based on the geo zone. The vehicle may then enforce the drive strategy such that the vehicle's operation complies with or follows the drive strategy.

A location-based drive strategy selection system comprises an input configured to receive a location of a vehicle; and a processor in communication with the input, the processor configured to select a drive strategy based on the location of the vehicle, and based on a time and a date at which the vehicle is present at the location.

A location-based drive strategy selection apparatus comprises an input configured to receive a location of a vehicle; and a processor in communication with the input, the processor configured to determine a drive strategy selected from at least one possible drive strategy, the drive strategy selected based on the location of the vehicle, and a time and a date when the vehicle is at the location, wherein the drive strategy determines a limitation of a vehicle operation.

A method of selecting a drive strategy comprises receiving a location of a vehicle; selecting a geo zone based on the location of the vehicle; and selecting a drive strategy based on the geo zone and a time and a date that the vehicle was located at the location.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system and method of operating the system of the present application may be more fully understood by reading the following description in conjunction with the drawings, in which

FIG. 1 is a block diagram of a location based drive strategy system;

FIG. 2 is a block diagram of geo zones used to inform the selection of a drive strategy;

FIG. 3 is a block diagram of a set of possible drive strategies; and

FIG. 4 is a flow diagram of a method for selecting a drive strategy based on a vehicle location.

### DETAILED DESCRIPTION

The described embodiments may be used to select a drive strategy for a vehicle based on the vehicle's location. A given geographical area may be divided into geo zones, and the vehicle's location may be used to determine which geo zone the vehicle is located within. The geo zone may have certain drive strategies associated with it. Depending on the make, model, or type of vehicle at the location with the geo zone, a certain drive strategy may be used by the vehicle. For example, a vehicle at a location X within geo zone A may select a drive strategy that forces the vehicle to generate less noise during operation by prohibiting the use of engine brakes. This particular drive strategy may be selected because geo zone A encompasses a residential neighborhood in which the use of engine brakes is prohibited.

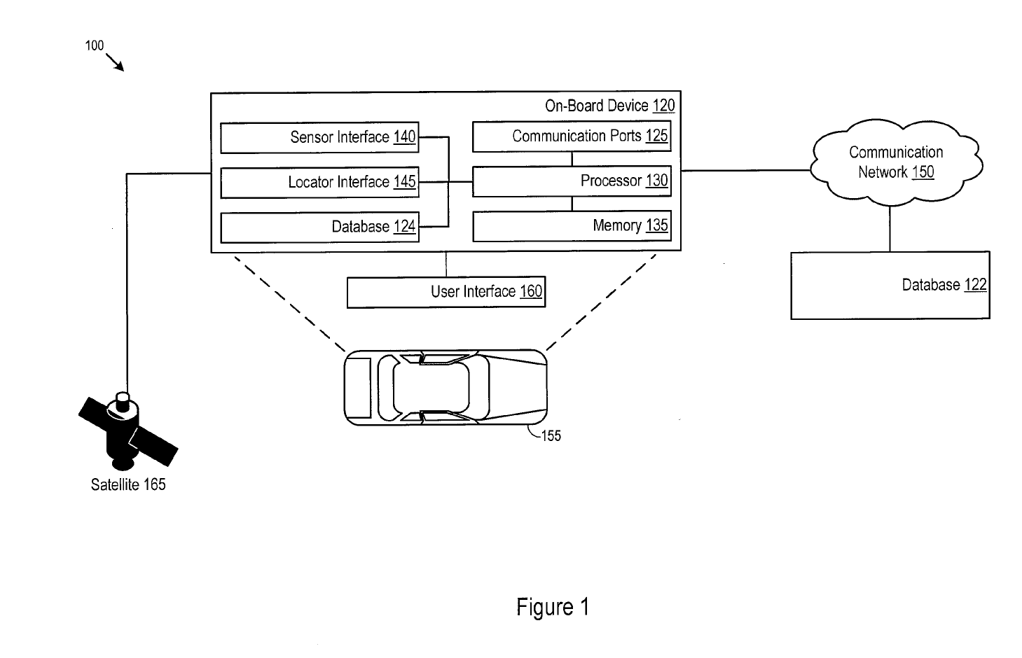

FIG. 1 illustrates a block diagram of a location based drive strategy system 100 according to one embodiment of the invention. Drive strategy system 100 includes vehicle 155. The exemplary vehicle 155 shown in FIG. 1 is an automobile. However, vehicle 155 may take any number of forms, including, as examples, a bus, truck, van, mini-van, sports utility vehicle (SUV), helicopter, airplane, construction vehicle, boat, trailer, all-terrain vehicle (ATV), motorcycle, moped, tractor, hybrid vehicle, electric vehicle, ambulance, marine vessel, boat, submarine, or other vehicle.

Vehicle 155 may include user interface 160, which may be communicatively linked to on-board device 120. Vehicle 155 may also include one or more occupants, e.g., a driver, one or more passengers, or any combination thereof. On-board device 120 may include communication ports 125, a processor 130, database 124, memory 135 that may store instructions or data, sensor interface 140, and locator interface 145.

On-board device 120 may communicate with any number of communication networks, including communication network 150, which may take any number of forms such as a cellular network. On-board device 120 may communicate according to any number of communication protocols, standards, networks, or topologies. As examples, on-board device 120 may communicate across cellular networks or standards (e.g., 2G, 3G, Universal Mobile Telecommunications System (UMTS), GSM (R) Association, Long Term Evolution (LTE) (TM), or more), WiMAX, Bluetooth, WiFi (including 802.11 a/b/g/n/ac or others), WiGig, Global Positioning System (GPS) networks, and others available at the time of the filing of this application or that may be developed in the future. On-board device 120 may include processing circuitry, data ports, transmitters, receivers, transceivers, or any combination thereof to communicate across any of the above-listed protocols, standards, networks, or topologies.

On-board device 120 may also communicate with any number of communication devices operated by occupants in vehicle 155. In one embodiment, on-board device 120 may implement a local area network (LAN) accessible by occupant communication devices, which may take the form of a wireless LAN (WLAN) or a wireless access point. Communication devices, such as hand-held smart phones, mobile phones, tablets, laptops, or other devices, may communicate directly with on-board device 120 through the WLAN. Alternatively, on-board device 120 may communicate with occupant communication devices indirectly, e.g., through one or more external communication networks, such as communication network 150, which may be a cellular network.

On-board device 120 may be configured according to any number of user requirements with respect to communication capabilities, data transfer configurations, data collection configurations, and other configurations. On-board device 120 may also collect any vehicle data, such as performance statistics, route information, position data, traffic data, and others. In one example, on-board device 120 may include telemetry functionality to collect and/or send vehicle data. These telemetry functions may include measurements or records of speed, direction, acceleration, pitch, yawl, and roll, and measurements or records of rate of change for speed, direction, acceleration, pitch, yawl, and roll. One example of on-board device 120 is the Openmatics© on-board unit provided by ZF Friedrichshafen AG.

On-board device 120 includes sensor interface 140 that may interface with one or more sensors in the vehicle. These sensors may include pressure sensors, gyroscopes, temperature sensors, voltage and current monitors, magnetic sensors, microelectromechanical sensors, mechatronic sensors, position sensors, and compass sensors. These sensors are merely exemplary and the embodiments are not limited to those sensors listed herein. Via sensor interface 140, on-board device 120 may collect various operating parameters that may be stored in database 124, memory 135, or transmitted over communication network 150 and stored in database 122.

Database 122 may be operated or maintained by the owner of vehicle 155. Alternatively, database 122 may be operated or maintained by a third-party that may grant access to database 122 to commercial or private operators and owners of vehicles. Database 122 may be distributed, such as in a cloud of distributed, networked computer servers.

On-board device 120 also includes locator interface 145. Locator interface 145 may be a GPS receiver that is able to receive transmissions from GPS satellites providing the vehicle with a means to determine its location on the earth. The GPS coordinates may be used together with a map software to provide the vehicle and its occupants with an indication of where the vehicle is located along a roadway, waterway, or anywhere on a map provided by the map software. Locator interface 145 may receive GPS transmissions from satellite 165.

In a typical application, on-board device 120 may be used as follows to select a drive strategy for a vehicle. As vehicle 155 travels along a route, on-board device 120 is tracking the location of vehicle 155 using GPS. GPS signals from satellite 165 may be received via locator interface 145. At specified intervals, on-board device 120 records GPS coordinates of vehicle 155.

On-board device 120 may use the GPS coordinates of vehicle 155 to determine which geo zone vehicle 155 may be located within. On-board device 120 may determine the geo zone of vehicle 155 by searching a database of geo zones using the GPS coordinates. The database of geo zones may be stored in database 124, memory 135, or database 122. On-board device 120 may access database 122 via communication network 150.

The geo zones may be based on political boundaries, such as city, county, or state limits. The geo zones may alternatively be based on abstract or arbitrary boundaries. The geo zones may further be based on boundaries selected based on land use in a given geographical area. For example, a geo zone boundary may be drawn to encompass a particular neighborhood, agricultural zone, residential zone, commercial zone, or industrial zone.

Each geo zone may have one or more drive strategies associated with it. For example, if a geo zone encompasses an industrial zone or area, then the drive strategy or drive strategies associated with that geo zone may result in a more noisy operation of vehicle 155. This may be because more noise is tolerated in the industrial area. A geo zone may have several drive strategies for multiple makes, models, and types of vehicles. Alternatively, a geo zone may have one generic drive strategy associated with it that is applicable to any vehicle, or may be applicable to only one type of vehicle.

Once on-board device 120 determines which geo zone vehicle 155 is located within, on-board device 120 may select the appropriate drive strategy for operation of vehicle 155 based on the determined geo zone. On-board device 120 may also use vehicle make, vehicle model, vehicle type, or other characteristics of vehicle 155 in selecting a drive strategy. For example, if a large truck is in a geo zone that is composed of a residential neighborhood, then on-board device 120 may select a drive strategy for that geo zone and particularly for a large truck. The selected drive strategy may, for example, not permit the truck to use engine brakes because it would be extremely noisy and disturbing for the residents living in the geo zone.

The advantage of the location-based drive strategy selection system is that different drive strategies may be selected and used for vehicle 155 as it travels through geographical areas having different levels of tolerance or allowance of certain effects of vehicle operation. It may not be a problem to use engine brakes or a shifting strategy that increase emissions in an industrial geo zone. However, use of engine brakes or a shift strategy that increases emissions may be problematic or even prohibited in a residential geo zone. Drive strategy selection system 100 advantageously facilitates the selection of an appropriate or legal drive strategy for a particular kind of vehicle. This reduces the risk of operator error, e.g., using engine brakes in a residential geo zone, and increases efficiency by implementing an appropriate drive strategy quickly, dynamically, and/or automatically as a vehicle travels through different geo zones.

The selected drive strategy may be implemented automatically. On-board device 120 may directly instruct various systems in vehicle 155, such as the engine, transmissions, brake system, or other system, to implement the drive strategy. For example, on-board device 120 may communicate with a controller of a transmission in vehicle 155 to instruct or command the controller to adjust its shift points in accordance with the selected drive strategy. Alternatively, on-board device 120 may inform the operator of vehicle 155 about the selection of a drive strategy using user interface 160. The details of the drive strategy may be displayed on user interface 160 so that the operator may implement the drive strategy manually.

A person other than the operator of vehicle 155 that seeks to monitor the status of vehicle 155, e.g., the vehicle's location, geo zone, and selected drive strategy, may receive communications about the status of vehicle 155. Such communications may include a text message, an image file, a video file, an e-mail, an audio file or sound, or other communications.

Depending on a direction of travel or preprogrammed route known to on-board device 120, on-board device 120 may be able to predict future geo zones that vehicle 155 will pass through. In this manner, on-board device 120 may be able to predict the future selected drive strategies imposed or suggested, whichever the case may be, in the future geo zones. On-board device 120 may analyze the predicted future drive strategies and adjust other predictions accordingly. For example, on-board device 120 may have been programmed with a specific route and may provide an estimated time of arrival depending on various inputs including speed, traffic reports, weather conditions, and other factors. A prediction of upcoming drive strategies may allow on-board device 120 to further refine its predicted estimate time of arrival. For example, a geo zone may not permit speeds, RPMs, or emissions to exceed a limit. Such limits may reduce the average speed of vehicle 155, and may accordingly affect the time of arrival. On-board device 120 may adjust its predicted estimate time of arrival accordingly.

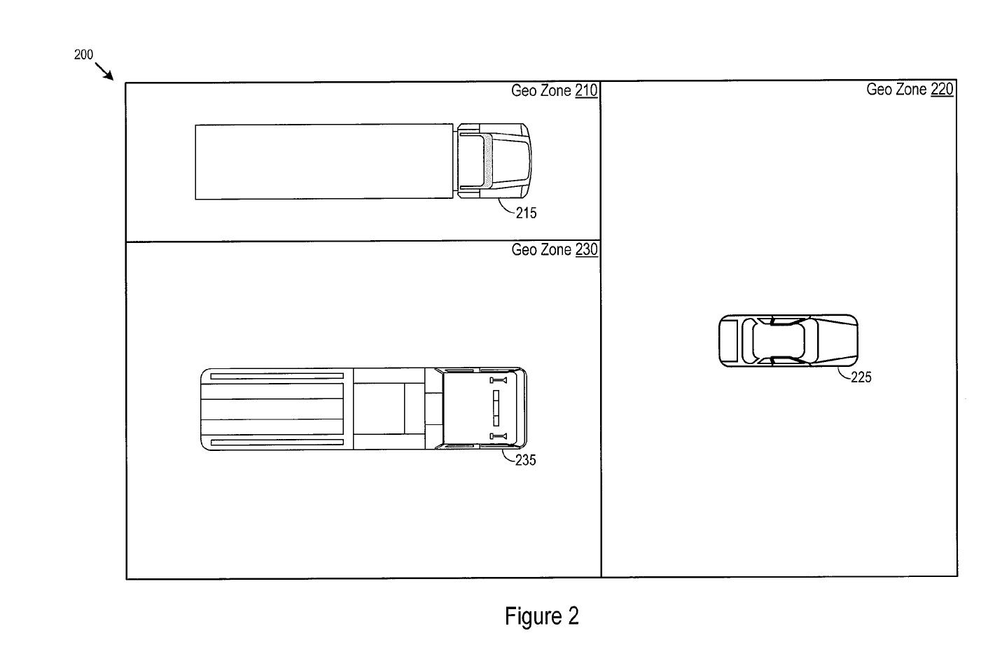

FIG. 2 depicts a block diagram of geo zones 200 used to inform the selection of a drive strategy according to one embodiment of the invention. Geo zones 200 are drawn as rectangles and are abstract in FIG. 2. However, geo zones 200 may take any shape and may be based on political boundaries, land use boundaries, or natural geographic lines such as rivers. Further, geo zones 200 are not necessarily drawn to scale with respect to vehicles 215, 225, and 235.

Geo zone 210 may represent a geographical area having relatively homogenous land use. For example, geo zone 210 may be primarily industrial, commercial, or residential land. Alternatively or additionally, geo zone 210 may have a relatively continuous and even population density. Geo zone 210 may have some common characteristic across the area within geo zone 210's boundaries such that a particularly drive strategy is desired within geo zone 210. The particular drive strategy may be based on the type of vehicle in geo zone 210. For example, truck 215 may be required to use a drive strategy in geo zone 210 that prohibits truck 215 from using engine brakes and performing other noisy operations. The required drive strategy may also require truck 215 to limit it emissions, speed, or RPMs.

The drive strategy imposed on truck 215 in geo zone 210 may change depending on the time and date that truck 215 is in geo zone 210. For example, the engine brake prohibition may only be in effect during evening hours, for example, from 9 PM until 7 AM. Another example is that the emissions limit imposed by the drive strategy in geo zone 210 for truck 215 is based on smog warnings issued or smog measurements taken in geo zone 210. On days when smog or other air pollutants is particularly high, a drive strategy emissions limitation may be increased such that truck 215 is required to further limit its emissions. Some limitations and requirements of the drive strategy for truck 215 within geo zone 210 may be static while others may be dynamic depending, for example, on the time, date, environmental conditions, and traffic congestion in geo zone 210.

Geo zone 220 may have characteristics different than geo zone 210, and therefore, may impose different drive strategies. As with geo zone 210, the particular drive strategy imposed on a vehicle in geo zone 220 may depend on the type of vehicle, and the time and date that the vehicle is in geo zone 220. Vehicle 225 is depicted as a sedan. Geo zone 220 may impose a less restricted drive strategy for a sedan or may impose a restricted drive strategy that is similar to that of a truck. Laws within geo zone 220 may require that two or more occupants be present within vehicle 225. Thus, a drive strategy for vehicle 225 associated with geo zone 220 may also require that two or more occupants be present in the vehicle. Occupant sensors located in vehicle 225 may provide input to a controller that is tasked with implementing the drive strategy. The owner or operator of vehicle 225 may be subject to a fine when vehicle 225 is operated in geo zone 220 with only one occupant present.

Geo zone 230 may have different characteristics than those of geo zones 210 and 220. For example geo zone 230 may encompass four city blocks and may include a fire station. Geo zone 230 may impose a drive strategy on fire truck 235 such that fire truck 235 may not use sirens and may not accelerate above a given threshold, for example, one meter per second per second (m/s²). Thus, geo zones may be localized to relatively small areas or may be larger in size to encompass entire regions of homogenous land use.

As described above, the drive strategies prescribed by a geo zone may be imposed on vehicles traveling in the geo zone. Use of a drive strategy may be enforced by local, state, or federal law enforcement officials. Further, regulations may be put in place requiring that vehicles be programmed such that a drive strategy imposed in geo zone is implemented by the vehicle. This may be advantageous where regulators seek to regulate a fleet of similarly situated vehicles, such as a commercial fleet of trucks, law enforcement and emergency vehicles, and other government owned vehicles. Alternatively, selection of the drive strategy in a geo zone may be merely recommended, and not imposed. In this case, it may be left to the vehicle operator to decide whether to accept and use the drive strategy of the geo zone.

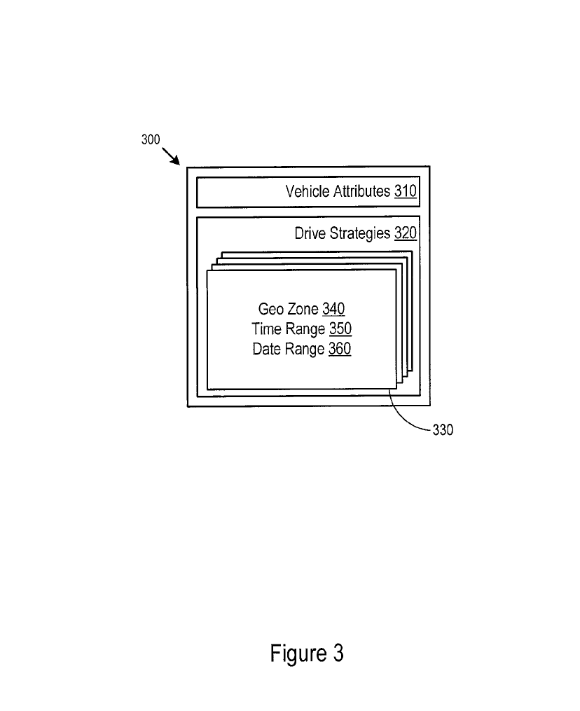

FIG. 3 depicts a block diagram of set 300 that includes drive strategies 320 according to another embodiment of the invention. Drive strategies 320 may include a different drive strategy for a number of geo zones, and for different date and time ranges. In this manner, set 300 may comprise an entire set of drive strategies 320 for a vehicle having vehicle attributes 310. Set 300 may be a complete set of drive strategies for a given area, such as the State of California, the United States, or North America.

Drive strategies 320 may include a drive strategy for a particular geo zone, date range, and time range for a particular vehicle having vehicle attributes 310. One such drive strategy is drive strategy 330. Drive strategy 330 is imposed in geo zone 340. Alternatively, drive strategy 330 may be imposed in multiple geo zones. Drive strategy 330 is imposed for a duration of time defined by date range 360 and time range 350.

Drive strategies 320 may be designed by various entities. For example, drive strategies 320 may be designed and implemented by the owner or operator of a fleet of vehicles, for example, commercial trucks. The operator of a large fleet may advantageously control the drive strategies of the fleet based on which geo zone a truck is travelling through. In this way, the commercial operator may limit the speed, fuel usage, or acceleration of the vehicle to increase the safety of the fleet's operation and to decrease the operator's liability for accidents.

Alternatively, drive strategies 320 may be designed, implemented, and/or promulgated by government entities. Local, state, and federal governments may seek to control drive strategies for various types of vehicles operating in certain geo zones. Governments may accomplish certain policy goals, such as reducing emissions, controlling noise, and increasing safety, by requiring that certain vehicles use drive strategies 320 in particularly geo zones.

Alternatively, private and public interest groups may pay to control the drive strategies of a geo zone. For example, the right to control the maximum RPMs of a vehicle operating in a geo zone that encompasses a neighborhood may be sold to a group of landowners owning land in that neighborhood. The right to control the maximum RPMs may allow the landowners to ultimately control the acceleration and top speed of vehicles operating in the geo zone.

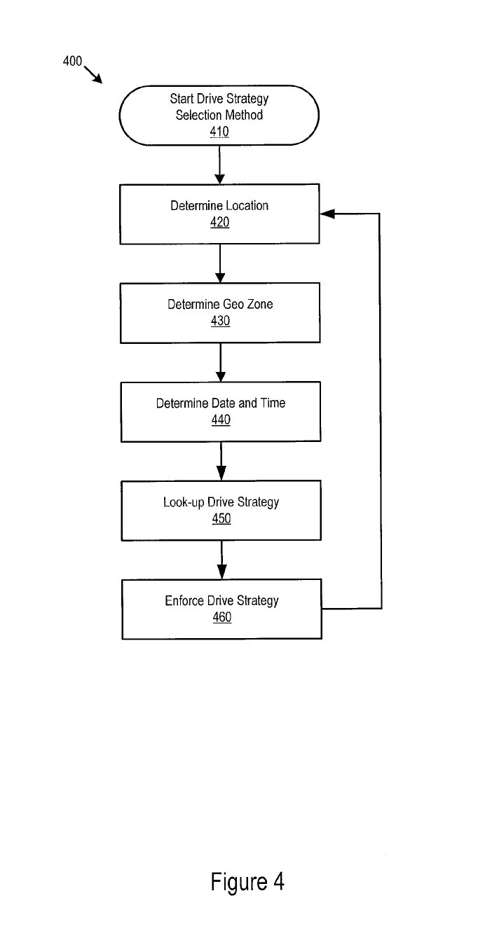

FIG. 4 depicts a flow diagram of method 400 that selects a drive strategy based on a vehicle location according to another embodiment of the invention. Method 400 begins at step 410 when an operator or system seeks to select a drive strategy for a vehicle. In step 420, the location of the vehicle is determined, for example, using GPS. In step 430, the geo zone in which the vehicle is operating is determined. Step 430 may rely on the location determined in step 420. In step 440, the current date and time is determined. This may be the date and time that the vehicle is currently operating at the location determined in step 420. In step 450, the drive strategy appropriate or required for the geo zone determined in step 430 is determined. Step 450 may also depend on the make, model, or type of vehicle seeking to select a drive strategy. In step 460, the drive strategy selected in step 450 is enforced in the vehicle. The vehicle may be required to use the drive strategy selected in step 450, and may therefore implement the drive strategy. The drive strategy may be stored in a memory that communicates with a controller or several controllers. The controller(s) may then send messages to various subsystems in the vehicle, such as the motor or transmission, to control the subsystems according to the selected drive strategy.

Alternatively, the drive strategy may not be required, but may be suggested or recommended. In this alternative, the operator of the vehicle or the owner of the vehicle may decide whether to use the recommended drive strategy.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A location-based drive strategy selection system comprising:
an input configured to receive a location of a vehicle; and
a processor in communication with the input, the processor configured to select a drive strategy based on a geo zone in which the vehicle is located, and based on a time and a date at which the vehicle is present at the location.

2. The location-based drive strategy selection system of claim 1 wherein the location is expressed in latitude and longitude coordinates.

3. The location-based drive strategy selection system of claim 1 wherein the processor is further configured to determine the geo zone based on a location of the vehicle.

4. The location-based drive strategy selection system of claim 3 wherein the geo zone is associated with a plurality of predetermined drive strategies.

5. The location-based drive strategy selection system of claim 4 wherein each drive strategy of the plurality of predetermined drive strategies is associated with a vehicle type.

6. The location-based drive strategy selection system of claim 1 wherein the drive strategy includes a target operating parameter of the vehicle.

7. The location-based drive strategy selection system of claim 6 wherein the target operating parameter of the vehicle is selected from a group consisting of speed, emissions, fuel economy, noise, and engine revolutions-per-minute.

8. The location-based drive strategy selection system of claim 7 wherein the processor is further configured to select the drive strategy based on a type of the vehicle.

9. The location-based drive strategy selection system of claim 1 further comprising a receiver in communication with the processor, wherein the processor is configured to receive drive strategy updates via the receiver.

10. The location-based drive strategy selection system of claim 9 wherein the processor is further configured to select a new drive strategy upon receiving the drive strategy updates.

11. The location-based drive strategy selection system of claim 3 wherein the processor is further configured to select a new drive strategy when the vehicle moves into a new geo zone, the new drive strategy based on the new geo zone.

12. The location-based drive strategy selection system of claim 4 wherein the processor is further configured to select a new drive strategy when the vehicle moves into a new geo zone, the new drive strategy based on the new geo zone.

13. A location-based drive strategy selection apparatus comprising:
an input configured to receive a location of a vehicle; and
a processor in communication with the input, the processor configured to determine a drive strategy selected from at least one possible drive strategy, the drive strategy selected based on the location of the vehicle, and a time and a date when the vehicle is at the location,
wherein the drive strategy determines a limitation of a vehicle operation.

14. The location-based drive strategy selection apparatus of claim 13 wherein the vehicle operation is selected from a group consisting of gear shifting, acceleration, braking, or internal combustion.

15. The location-based drive strategy selection apparatus of claim 13 wherein the drive strategy includes a noise limitation that manages the operation of the vehicle to maintain a noise level of the vehicle below a predetermined value.

16. A method of selecting a drive strategy comprising:
receiving a location of a vehicle;
selecting a geo zone based on the location of the vehicle; and
selecting a drive strategy based on the geo zone and a time and a date that the vehicle was located at the location.

17. The method of claim 16 wherein the geo zone is selected based on the location of the vehicle and a characteristic of the vehicle.

18. The method of claim 17 wherein the characteristic of the vehicle is selected from a group consisting of vehicle make, vehicle model, or vehicle type.

19. The method of claim 16 wherein the drive strategy is promulgated by a government agency.

20. The method of claim 16 wherein the drive strategy is enforced by the vehicle.
